(19) United States
(12) Patent Application Publication
(10) Pub. No.: US 2007/0007361 A1
(43) Pub. Date: Jan. 11, 2007

(54) Wall fountain structure and method of attachment

(76) Inventor: William A. Rose, Lake Forest, CA (US)

Correspondence Address: PATENT LAW & VENTURE GROUP, 2424 S.E. BRISTOL, SUITE 300, NEWPORT BEACH, CA, 92660, US

(21) Appl. No.: 11/176,473

(22) Filed: Jul. 6, 2005

(51) Int. Cl. B05B 17/08

(52) U.S. Cl. 239/17; 239/275; 239/279

(57) ABSTRACT

A decorative fixture is mounted on fountain support such as a well by a fastener. A first tube extends from an interior portion of the fountain support to a terminating position proximate a face surface thereof. A second tube extends from a position proximate a frontal surface of the decorative fixture to a position proximate its mounting surface. A tube coupling joins the first and second tubes within a hollowed-out space in the fountain support or the decorative fixture or partially in both. The coupling is engaged with the tubes, and the fastener is likewise secured by a permanent or non-permanent bonding agent.

### BACKGROUND

1. Related Applications

none

2. Field of the Present Disclosure

This disclosure relates generally to garden fountains and more particularly to wall mounted fountains and methods of interconnecting such fountains to a source of water and also to the joining of such fountains securely to a wall.

3. Description of Related Art

The following art defines the present state of this field and each U.S. disclosure is hereby incorporated herein by reference:

Lynn, U.S. 2001/0029625, discloses a method for adjusting the temperature of a swimming pool having a filter system and a waterfall, comprising running the filter system at times of the day such that heat transfer with ambient air is optimized by the action of swimming pool water falling through the ambient air, and further comprising positioning and substantially fixing the position of a movable surface below the water fall to help maximize the heat transfer with the ambient air. For pools without waterfalls, it is further disclosed to utilize a conduit from a submerged water return opening to the movable surface which could be a raft.

Nary, U.S 2004/0069860, discloses a swimming pool fountain that includes a bracket that is easily connected to the water supply of the swimming pool and is secured in a stable position relative to the wall of the pool. Means are provided for changing the vertical elevation of the fountainhead to the desired level relative to the water level of the pool. Also, the arrangement is such that it minimizes the problem of injury to swimmers and pool circulation plumbing by providing for separation upon a load being imposed on the structure. The same connection facilitates removal of the fountain structure from the pool if it should be desired and use can easily be made to the fountainhead to change the artistic aspects of the fountain.

Williams, U.S. Pat. No. 3,318,528 discloses a combination swimming pool and recirculating filter system for said pool including a water return line through which filtered water from the pool is returned to the pool, the return line extending through the sidewall of the pool below the normal water level in the pool and having an open end exposed at the inner side of said wall below open end exposed at the inner side of the wall below the normal water level through which the filtered water normally discharges into the pool; and an ornamental fountain including a water conduit, a fitting on one end of the conduit press-fitted in the open end of the return line, the opposite end of the conduit being located above the normal water level, and a spray head on the opposite end of the conduit.

Greene, U.S. Pat. No. 3,749,424, discloses a water conduit connector which is particularly adapted to connect a water conduit to the wall of a swimming pool in a water-tight manner, the swimming pool being formed of an outer rigid sheet material layer and an interior plastic water-tight layer, the connector including a cylindrical tubular member extending through an opening through both of the interior layer and the outer layer, an annular collar extending from the tubular member and located between the interior layer and the outer layers, a washer to surround the tubular member and adapted to come into contact with the interior layer and frictionally bind such to the annular collar, the washer including a plurality of spaced apart radial ridges to resist rotational movement between the washer and the interior layer, a lock nut to be engaged with the tubular member and be in contact with the washer, the lock nut including a plurality of concentrically disposed rings which are to contact the washer and upon such being tightened, a minimal amount of torque is created tending to rotate the washer.

Ryan, U.S. Pat. No. 4,936,506, discloses a swimming pool fountain which can be installed in any existing pool, hot tub, spa or the like and is capable of adjustment to any water level height, variation in spray pattern, pinch and direction, and illumination of the fountain spray.

Saputo, U.S. Pat. No. 5,881,401, discloses a turbo return fitting for placement in a swimming pool that includes a side wall, a bottom wall, a return port having an internal thread extending from the side wall, a skimmer port positioned on a side of the side wall of the swimming pool opposite the return port and a gutter extending around a top of the side wall. The turbo return fitting includes an adjustable tubular body including a first end having an external thread spiraling there around for mating with the internal thread in the return port and a second end having an external thread spiraling there around. An adjustable spray nozzle including a spray template having perforations for controlling a flow pattern and pressure of water flowing therethrough is connected to the adjustable tubular body. The adjustable tubular body is rotatable about the return port between a first position directing said spray nozzle toward the bottom wall for cleaning the bottom wall; a second position directing said spray nozzle toward the side wall for cleaning the side wall; a third position directing said spray nozzle toward the top of the swimming pool for creating a fountain effect; and a fourth position directing said spray nozzle toward a surface of the water in the swimming pool to skim the surface of the pool. The spray template is adjustable to maximize the effect of the turbo return device.

Ruthenberg, U.S. Pat. No. 6,196,471, discloses an apparatus for creating a multi-colored illuminated waterfall that includes a waterfall vessel, a clear tube disposed within the vessel, LED bulbs mounted on a circuit board strip which is disposed within the clear tube and a controller circuit which sequentially activates predetermined arrays of different colored LED bulbs. The waterfall vessel has baffles for suppressing turbulence and optional reflective film for enhancing emitted light. A controller circuit is included to sequentially light predetermined arrays of different colored LED bulbs. A rectifier circuit is included to convert a 12 volt ac circuit to a 12 volt dc circuit and a transformer reduces a 110 volt ac power source to a 12 volt ac supply. In an embodiment for a water fountain, the circuit board strip with the LED bulbs are instead disposed within a branch of a tee with a clear lens separating the LED bulbs from the water flow portion of the tee. Water flows into a second branch of the tee and out the third branch of the tee through a discharge tube with a swivel connection at the third branch of the tee to direct the discharge tube through an aperture in a facade. The third branch of the tee includes longitudinal baffles for suppressing turbulence and an optional laminate of reflective film to enhance emitted light.

Souza, U.S. Pat. No. 5,217,161, discloses a swimming pool sculpture that is mounted on the edge of an above-the-ground pool. Recirculating water from the pool's filtration system is redirected back into the pool through the sculpture in the nature of a “spray” or “stream”. In a preferred embodiment, the sculpture has a body portion secured to the ledge of the pool, and rotatable head portion through which the “spray” or “stream” is directed; with the head being interchangeable with others of like design, a swimming pool toy-accessory of different appearance and/or “spray pattern” may be provided, and one which requires no complex moving parts or piping systems, makes full use of the water available in the system, and maintains the whole area of the pool available for swimming. In an alternative construction of the invention, a valve may be added, to vary the pressure of the recirculating water introduced into the sculpture, and, thereby control the distance of the “spray” or “stream” into the pool.

Koren, U.S. Pat. No. 6,393,192, discloses a water feature that provides for both water and an illuminating optical fiber to pass through a single tube. The tube is sealingly connected to a housing having separate inlets for water and the fiber optic cable. A fitting connected between the tubing and the housing allows water to flow through the annulus between the fiber outside diameter and the tubing inside diameter. Water provided to the fitting from a water source passes through the tubing into a fixture where it then exits to form a waterfall or other water display. Light emitted from an end of the fiber optic cable illuminates the water display. By using a transparent or translucent tube, light emitted from along the length of the cable may be used to illuminate the translucent fixture itself.

Our prior art search with abstracts described above teaches the plumbing of water supply tubes and pipes for fountains and other applications. This prior art shows that it is known to direct a water delivery tube as a single conduit from water source through the wall mounted fixture without interruption, to provide threaded stub-outs in walls, to mount a tube to a relatively thin wall by compression coupling means, to mount a fixture using a rotational threaded fitting on a threaded stub-out, and to penetrate walls by conduits using feedthroughs. However, the prior art fails to teach the joining of tubes or pipes facilitated by a hollowed-out space in either the wall or the decorative fixture, especially by a hollowed-out space within the wall. The prior art also fails to teach the use of a non-permanent bonding of tubes and mounting hardware to facilitate later removal, or the use of a straight tubular joint coupler. The present disclosure distinguishes over the prior art providing these heretofore unknown advantages as described in the following summary.

### SUMMARY

This disclosure teaches certain benefits in construction and use which give rise to the objectives described below.

Water features are quite often included in garden settings. Such water features include pools, fountains, spas, hot-tubes, ponds, streams and other natural and man-made decorative elements. A very common water feature in contemporary gardens is a wall mounted fixture with water tubes directing a flow of water through and thence out from it to a catch basin or similar element. Such fountains are made commercially available through such companies as: Wall Fountains, US, El Cajon, Calif.; Statue.Com, Edwardsville, Ill.; and Serenity Health-Starport Systems, Yelm, Wash. As can be seen from the above described Koren reference, U.S. Pat. No. 6,393,192, the universal means for directing water through a wall mounted fixture is to direct a continuous tube from the source of water, through the wall and through the fixture to its outlet. However, this presents a problem in several circumstances, for instance, when the water delivery tube terminates at a position recessed within the wall to which the fixture is to be mounted. This may occur when refurbishing old construction. A problem arises also when an existing water delivery tube is of a different gauge then that of the tube in the fixture that is to be mounted. Finally, a further problem arises when it is desired to remove the fixture at some future time without demolishing it. For these and many other problem circumstances, the present embodiments provide an apparatus and method of its use that overcomes these issues and provides further benefits as will be described herein.

A decorative water issuing decorative fixture is mounted on fountain support, such as a wall by fasteners such as studs or bolts. A first tube, the water delivery tube, extends from the interior of the wall, a fountain support structure, to a terminating position proximate a face surface of the wall, either shy of the surface or extending outwardly from the surface or exactly even with the surface. A second tube, or water conduit, the fixture tube, extends from a position proximate a frontal surface of the decorative fixture to a position proximate its mounting surface, either recessed within the fixture, even with its mounting surface or extending outwardly from the mounting surface. A tube coupling joins the first and second tubes within a hollowed-out space in the fountain support or in the decorative fixture or partially in both depending upon the relative positions of the terminating ends of the two tubes. The coupling is engaged with the tubes, and the fasteners are likewise secured in place by a permanent or non-permanent bonding agent. At the heart of this system is the hollowed-out space, as this allows access to the end of the recessed tube and enables the placement of the coupling. For instance, when PVC pipe is used, it is necessary to prepare the ends of the tubes by roughening them and possibly cutting their tips normally and also for applying the bonding agent. These steps cannot be taken without a hollow space of adequate size.

A primary objective inherent in the above described apparatus and method of use is to provide advantages not taught by the prior art.

Another objective is provide an apparatus and method that will compensate for old, rusted, corroded and recessed water delivery pipes or tubes within walls, making it relatively easy to mount a water dispensing fixture thereto.

A further objective is to provide an apparatus and method that enables the interconnection of a water dispensing fixture to a wall when the tube or pipe sizes are different.

A still further objective is to provide an apparatus and method that enables a water dispensing fixture to be mounted to a wall or other mounting structure and to thereafter be removed without destruction of the fixture.

A still further objective is to provide an apparatus and method that enables the mounting of a water dispensing fixture when a source pipe and a dispensing pipe in the fixture are laterally misaligned.

Other features and advantages of the described apparatus and method of use will become apparent from the following more detailed description, taken in conjunction with the accompanying drawings, which illustrate, by way of example, the principles of the presently described apparatus and method of its use.

### BRIEF DESCRIPTION OF THE DRAWINGS

The accompanying drawings illustrate at least one of the best mode embodiments of the present apparatus and method of it use. In such drawings:

FIG. 1 is a spaced apart vertical sectional view of a first embodiment of the present disclosure;

FIG. 2 is a vertical sectional view thereof as assembled;

FIG. 3 is a perspective view thereof;

FIG. 4 is a spaced apart vertical sectional view of a second embodiment of the present disclosure;

FIG. 5 is a vertical sectional view thereof as assembled; and

FIG. 6 is a perspective view thereof.

### DETAILED DESCRIPTION

The above described drawing figures illustrate the described apparatus and its method of use in at least one of its preferred, best mode embodiment, which is further defined in detail in the following description. Those having ordinary skill in the art may be able to make alterations and modifications what is described herein without departing from its spirit and scope. Therefore, it must be understood that what is illustrated is set forth only for the purposes of example and that it should not be taken as a limitation in the scope of the present apparatus and method of use.

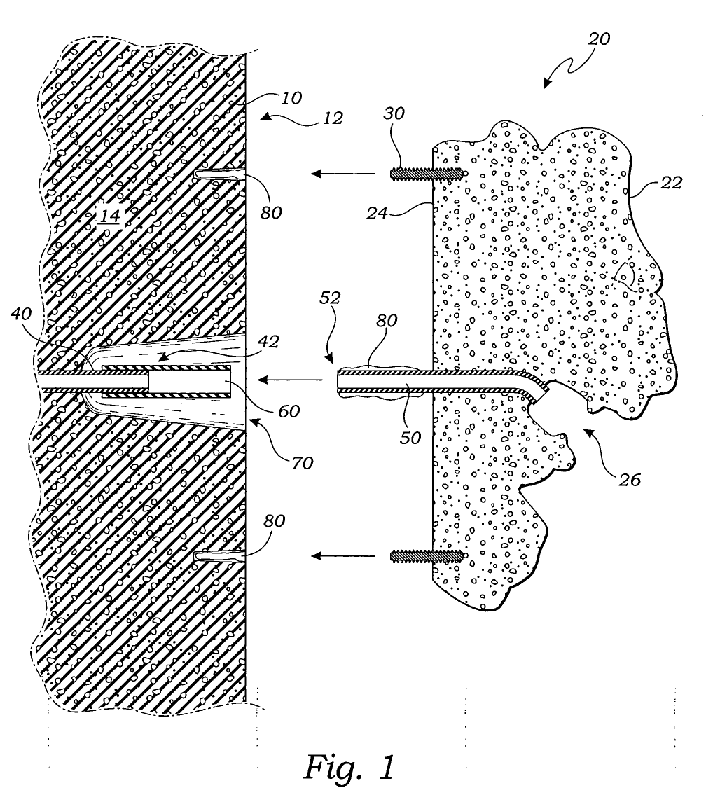

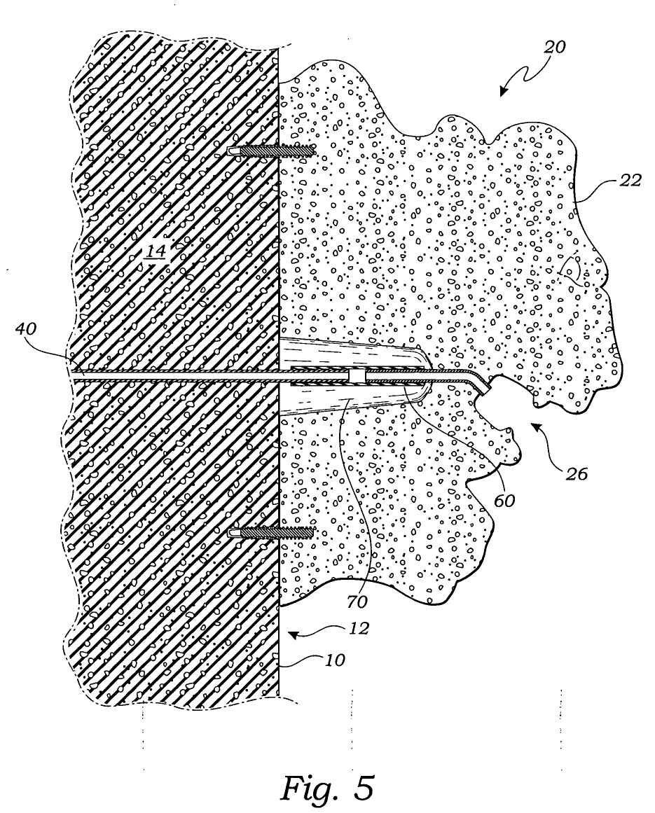

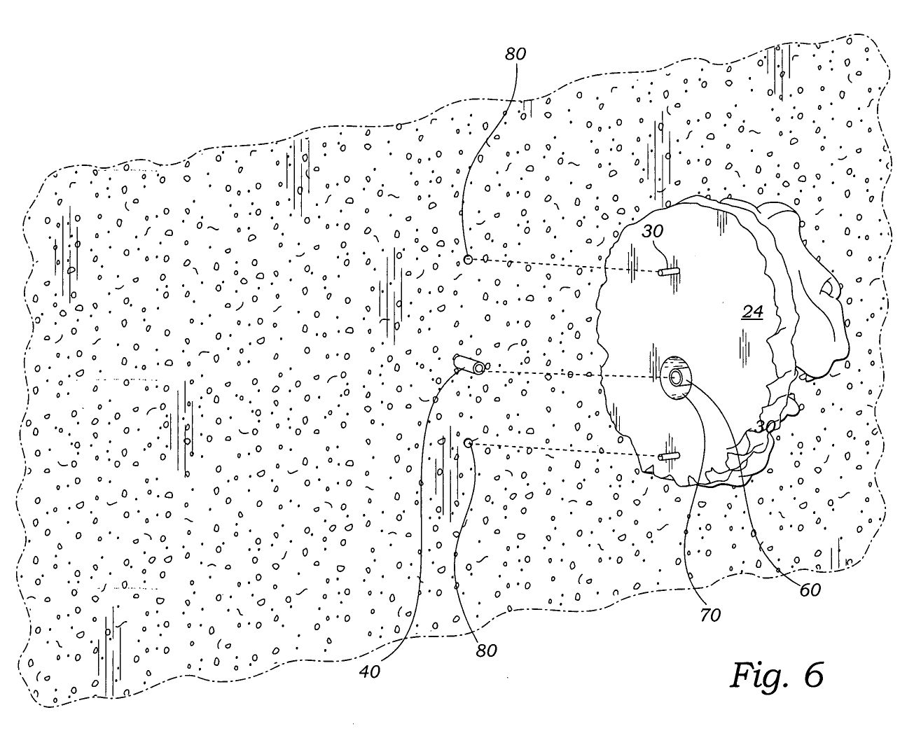

The present apparatus comprises a fountain support 10 having a face surface 12, and a decorative fixture 20 providing a decorative outer surface 22 and, in opposition thereto, a mounting surface 24. A fastener 30 engages the decorative fixture 20 with the fountain support 10. As shown in FIGS. 1-6, the fountain support 10 may be a wall, as shown in the figures, but it may also be any structural element designed to support the decorative fixture 20 and through which a means may be formed to direct a water flow. The term “decorative fixture” as used herein is directed primarily to a wall mounted unit for dispensing a water stream, but those of skill in this art would find it routine to provide alternate forms still in keeping with the scope of this description. Such a water flow may thereafter be directed from the decorative fixture 20 into a fountain bowl, a stream bed or any other water receiver for recirculation or not. We are not specifically concerned, here, with the receiver of the water, but only with the means by which the water flow may be directed through the decorative fixture 20 to be disbursed therefrom.

The decorative fixture 20 may be a lions head, a common motif, as shown in the accompanying figures, but it may also by any other configuration or design as well known in the garden fountain industry, and which may be substituted for such a lions head without loss of the particular inventive elements as described and shown herein. The mounting surface 24 of the decorative fixture 20 is secured in intimate contact by the fastener 30 against the face surface 12. Such a fastener 30 may be one or, preferably plural bolts, studs, rods or the like, as shown in the figures. Such a fastener 30 may actually be any fastening device, known now, or developed at a future time, that enables the primary function of attaching the decorative fixture 20 to the fountain support 10.

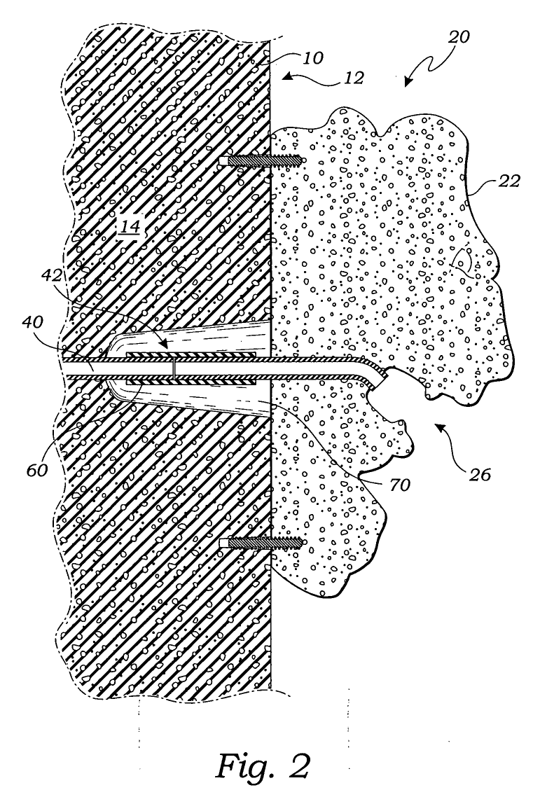

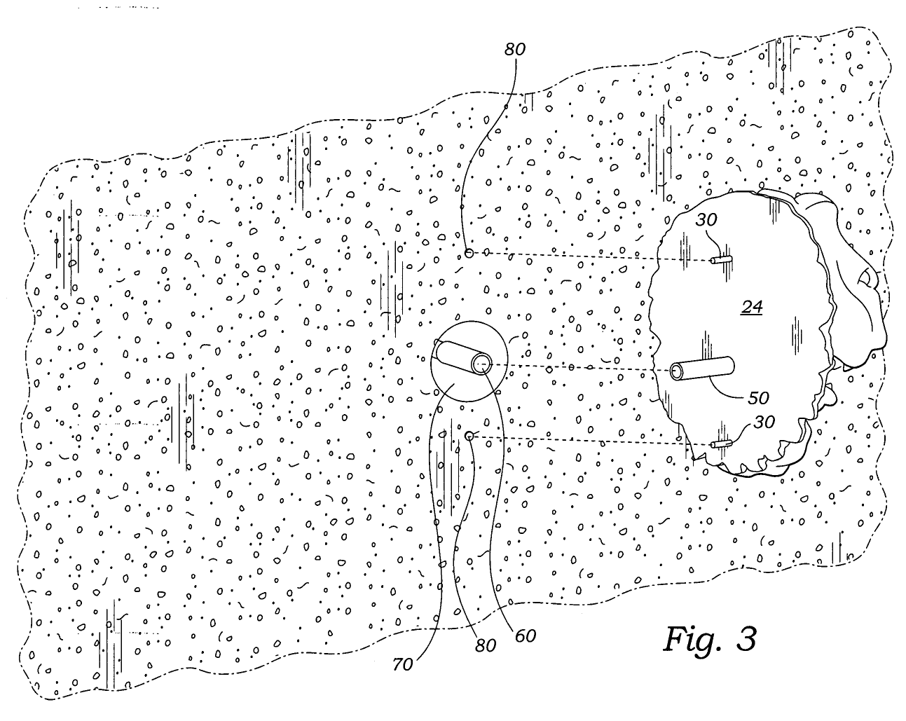

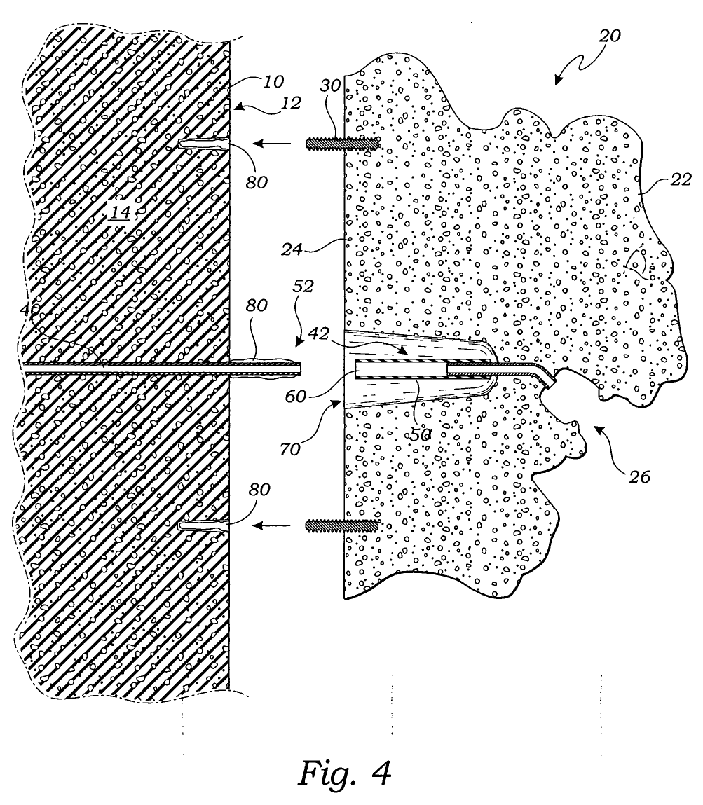

A first tube 40 extends from an interior portion 14 of the fountain support 10 to a terminating position 42 proximate the face surface 12. A second tube 50 extends from a position 26 proximate the decorative outer surface 22 of the decorative fixture 10 to a position 52 proximate the mounting surface 24. The tubes 40 and 50 are preferably of a polyvinyl chloride (PVC) material and at least one portion, preferably the terminal end, of one or both of the tubes 40 and 50 are preferably flexible. Such flexibility enables the fixture 10 to be placed without having to assure that the tubes 40 and 50 are aligned colinearly. The first 40 and second 50 tubes are joined by a tube coupling 60, also preferably of PVC, within a hollow space 70, in at least one of the fountain support 10, as shown in FIGS. 1 and 2, or the decorative fixture 20, as shown in FIGS. 3 and 4. The hollow space 70 may be placed partially in both the support 10 and the fixture 20 and must be large enough to gain finger entrance for preparing the surfaces of the first 40 and/or the second 50 tubes so as to roughen the exterior surfaces of these tubes for improved bonding, or to clean these surfaces of debris, or for other enablement. The size of the hollow space to provide for this enablement is considered a critical factor in this invention, and one that provides clear distinction over the prior art. The coupling 60 is engaged with the first 40 and the second 50 tubes, preferably with the tubes abutting, joining their ends in a water-tight seal and allowing water to flow from tube 40 into tube 50 and thus outwardly to the decorative fixture 20 for being discharged. Both the coupling 60 and the fastener 30 are secured by a bonding agent 80 of either a permanent type or a non-permanent type depending upon whether it is contemplated to remove the decorative fixture 20 at a future time. The permanent agent may be a PVC cement or the like, a grout, or an epoxy bonding agent or similar materials. The non-permanent agent may be a non-setting caulking compound or a silicon rubber cement. Such materials are very well known in the commercial market place, but it is considered to be a novelty distinct from the prior art to apply a wall fountain fixture with a non-hard setting agent so as to enable future removal without damage to the fixture. This is an important inventive element in the present solution. It is clear that other adaptors may be used in the present apparatus. For instance a PVC male adaptor having its threaded end turned down to fit snugly into a copper fitting (part of tube 50) may be used to advantage.

The apparatus described above is considered novel for reasons given previously, and its method of application is as well, as will now be described. The method of securing the decorative fixture 20 to the fountain support 10 includes preparing the face surface 12 on the fountain support 10 and likewise; preparing the mounting surface 24 on the decorative fixture 20. These surfaces are brought together into contact as shown in FIGS. 2 and 4 so that they are preferably planar or otherwise complimentary shaped surfaces, one fitting intimately against the other. The hollow space 70 is formed in the fountain support 10 or in the decorative fixture 20 or both, as shown in FIGS. 1 and 3. The first tube 40 is place and extended from the interior portion 14 of the fountain support 10 to the terminating position 42 proximate the face surface 12. The second tube 50 is extended from the position 26 proximate the frontal surface 22 of the decorative fixture 20 to a position 52 proximate the mounting surface 24. Finally, the first 40 and second 50 tubes are joined by the tube coupling 60 within the hollow space 70, and at the same time the fastener 30 is positioned for securing the decorative fixture 20 in place, using one of the bonding agents 80 previously described. In order to assure that the coupling 60 is properly set onto the tubes 40, 50, i.e., properly abutting medially within coupling 60, it is necessary to secure the coupling 60 in place on tube 40 first and, only then, insert tube 50 into the coupling 60 as the decorative fixture 20 is mounted. The object here is to avoid pushing the coupling 60 along tube 40 while attempting to insert tube 50 into it. Alternatively, the coupling 60 may be secured onto tube 50 first prior to mounting the decorative fixture 20.

Clearly, as described above, the coupling 60 is secured within the hollow space 70 and this may position the coupling 60 within the interior of the fountain support 10, within the decorative fixture 20, or positioned partially within each. If it is desired to produce the least amount of damage to the fountain support 10, the hollow space 70 and the coupling 60 will be placed within the decorative fixture 20, and when the decorative fixture 20 is not amenable to receiving such a hollow space 70, the fountain support 10 is the preferred location for the hollow space 70.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

What is claimed is:

1. An apparatus comprising: a fountain support having a face surface; a decorative fixture providing a decorative frontal surface and, in opposition thereto, a mounting surface; a fastener securing the decorative fixture to the fountain support, the mounting surface intimately abutting the face surface; a first tube extending from an interior portion of the fountain support to a terminating position proximate the face surface; a second tube extending from a position proximate the frontal surface of the decorative fixture to a position proximate the mounting surface; and a tube coupling joining the first and second tubes within a hollow space in at least one of: the fountain support, and the decorative fixture, the hollow space of such dimension as to enable finger access to the exterior surface of at least one of the first and the second tubes; the coupling engaged with the first and the second tubes, and secured by a bonding agent; the fastener further secured by a bonding agent; wherein the mounting surface contacts the face surface before the first and second tubes, when engaged within the coupling, contact each other.

2. The apparatus of claim 1 wherein tubes one and two are of different outside diameters.

3. The apparatus of claim 1 wherein the first tube terminates at a recessed position within the fountain support.

4. The apparatus of claim 1 wherein the first tube terminates exteriorly to the face surface.

5. The apparatus of claim 3 wherein the second tube terminates exteriorly to the mounting surface.

6. The apparatus of claim 4 wherein the second tube terminates at a recessed position within the decorative fixture.

7. The apparatus of claim 1 wherein at least one of the first and second tubes has at least one portion that is flexible.

8. A method of securing a decorative fixture on a fountain support, the method comprising the steps of: preparing a hollow space of a size for enabling finger access into at least one of: a face surface in the decorative fixture, and, a mounting surface in the fountain support; extending a first tube from an interior portion of the fountain support to a terminating position proximate the face surface; extending a second tube from a position proximate a frontal surface of the decorative fixture to a position proximate the mounting surface; moving the mounting surface into contact with the face surface; joining the first and second tubes by a tube coupling within the hollow space in at least one of: the fountain support, and the decorative fixture using a bonding agent; and joining the mounting surface of the decorative fixture with the face surface of the fountain support using a fastener with a bonding agent.

9. The method of claim 8 further comprising the step of providing the first and second tubes with different diameters.

10. The method of claim 8 further comprising the step of terminating the first tube at a recessed position within the fountain support.

11. The method of claim 8 further comprising the step of terminating the first tube exteriorly to the face surface.

12. The method of claim 10 further comprising the step of terminating the second tube exteriorly to the mounting surface.

13. The method of claim 11 further comprising the step of terminating the second tube at a recessed position within the decorative fixture.

14. The apparatus of claim 8 further comprising the step of forming at least one of the first and second tubes with at least one flexible portion.
